(19) United States
(12) Patent Application Publication
(10) Pub. No.: US 2004/0158403 A1
(43) Pub. Date: Aug. 12, 2004

(54) Method for processing georefrenced electrical resistivity measurements for the real-time electrical mapping of soil

(76) Inventors: Michel Dabas, Paris (FR); Jeanne Tabbagh, Paris (FR); Sebastien Flageul, Ivry Sur Seine (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/470,269

(22) PCT Filed: Feb. 6, 2002
(86) PCT No.: PCT/FR02/00465

(30) Foreign Application Priority Data
Feb. 7, 2001 (FR) 01 01655

(51) Int. Cl. G01V 3/00

(52) U.S. Cl. 702/2

(57) ABSTRACT

The invention relates to a method for processing georeferenced electrical resistivity measurements for electrical ground mapping. The area of a ground to be mapped is cut into a thin grid of points. According to the invention, measuring means enable to obtain n parameters (n being equal to at least 3) characterising the electrical resistivity at a given point at n different depths. Positioning means also enable to obtain, for a number k of measured points, an absolute positioning measurement and k relative displacement measurements. The three sets of measurements obtained are sent to a microcontroller which synchronises the acquisitions. The data sent by the microcontroller to a computer is processed digitally and in real time. A profile showing the sequential variations for a given depth of the ground resistivity through the area studied and a map showing the position of the measuring means are finally visualised simultaneously and in real time on two different display windows.

Possible applications in Precision Agriculture and the prospection of archaeological sites.

For a number of years, a new approach to agriculture has emerged, Precision Agriculture. This approach is based on matching agricultural processes with local conditions of the surrounding.

This approach intends not only to maximise the output of the grounds cultivated and to reduce the costs, but also to respect the environment more stringently, which should lead to scarcer usage of intrant doses used (seeds, fertilisers, phytopathological products).

With a view to optimising the output of the grounds cultivated, it is important to know simultaneously the texture of a given ground or the constitutive particles of this ground and the depth of superficial soil that can be cultivated. Thus, high clay ratio, high salinity may affect the output of a plot. It is therefore beneficial to proceed to recognition of the soils of a farm plot and to establish the homogeneous zones thereof. Specific and appropriate treatment could then be determined for a given area in order to maximise the output thereof.

A method then consists in performing direct measurements, i.e. auger borings and pitch digging. On top of the punctual aspect of such measurements, they have the disadvantage of being destructive, costly and of modifying the structure of the area studied after boring (irreversible effect). This type of measurement does not enable to map the homogeneous areas reliably and with sufficient details, for a farm plot for Precision Agriculture.

Another method consists in using data supplied by airborne or satellite means. However, such data correspond to minimum areas of terrains vastly larger than the current dimensions of the farm plots in Europe. Consequently, they cannot be exploited for Precision Agriculture which requires accurate spatial knowledge of the grounds of the order of ten metres.

A method intended to define homogeneous areas by a system for measuring the electrical resistivity of the grounds described notably in a communication by Dabas and al. [Sociétédes Electriciens et des Electroniciens—Feb. 5, 1987], in an article by Panissod and al. [Geophysical Prospecting; 45 (1997) 983] and in the U.S. Pat. No. 5,841,282 is known. This direct physical measurement is correlated with the properties and the structure of the grounds measured (porosity, water resources, clay ratio, etc.) and enables therefore to define the homogeneous areas of a plot. These measurements are performed continuously by injecting a current into the ground and by measuring the resulting potential thanks to other electrodes in contact with the ground to be characterised. These measurements are georeferenced in an absolute fashion (GPS). This measuring system exhibits, however, a double disadvantage. The measurements recorded by said system are not processed and, consequently, cannot be visualised in real time by an on-board computer. The measurements are recorded then processed at a later stage after measuring the farm plot. It is therefore not possible, for example, to couple this measuring system to spreading means and to adapt in real time the intrant dose necessary to a specific area to be treated.

The aim of the present invention is therefore to provide a method for processing georeferenced electrical resistivity measurements for realtime electrical ground mapping. This method, simple in its design and in its implementation, should enable, in addition to a technical breakthrough, significant reduction of the costs associated with ground mapping. Precision Agriculture should become far more widespread in the farm world with its benefits inherent for the environment.

In this view, the invention relates to a method for processing georeferenced electrical resistivity measurements for electrical ground mapping wherein:

the area of a ground to be mapped is cut into a grid of points defined by the repetition of the same elementary mesh,

measuring means are moved in the area to be mapped,

as measuring means are moved, at least one measurement of the electrical resistivity is made continuously at each point,

positioning means are used for geographical and absolute referencing of the measurement associated with each point,

the data recorded is processed digitally,

a map showing the variations for a given depth of the electrical resistivity of the ground is visualised.

According to the invention,

the electrical resistivity is recorded for each point at n different depths, n being at least equal to 3,

said positioning means enable to obtain, for each point measured, a relative displacement measurement with respect to the previous point,

the three sets of measurements obtained are sent to a microcontroller which synchronises the acquisitions,

In different particular embodiments, each with its own advantages and liable to numerous technically possible combinations:

the data sent by the microcontroller to a computer is processed digitally and in real time,

a profile showing the sequential variations for a given depth of the ground resistivity through the area studied and a map showing the position of the measuring means are visualised simultaneously and in real time on two different display windows,

before collecting said measurements, the scale of the map of the second display window is defined, during the preliminary survey of the area to be mapped, whereas said survey is recorded on the computer by a particular programmed procedure,

a guiding system is used to control the displacement of the means for measuring the relative displacements, the electrical resistivity and the absolute positioning between the points,

the measurement of the relative displacements is obtained by a Doppler radar,

the measurement of the relative displacements is obtained by an incremental encoder,

the measurement of the relative displacements is obtained by a system capable of delivering TTL pulses according to the displacement of the measuring means,

the sets of resistivity measurements and of relative positioning measurements between two absolute coordinates are processed statistically at the computer in order to eliminate faulty resistivity values and to fine-tune the positioning measurement,

the resistivity is measured at constant current.

The invention will be described more in detail with reference to the appended drawings wherein:

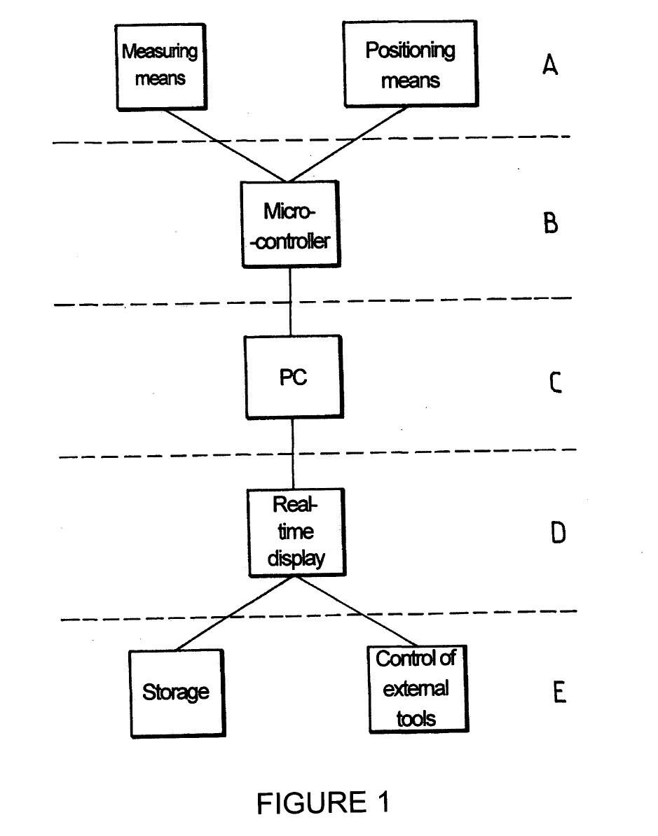

FIG. 1 is a diagrammatical representation of the successive steps a), b), c), d) and e) leading to visualisation of a map of the resistivity and positioning measurements, and the storage thereof, according to the invention;

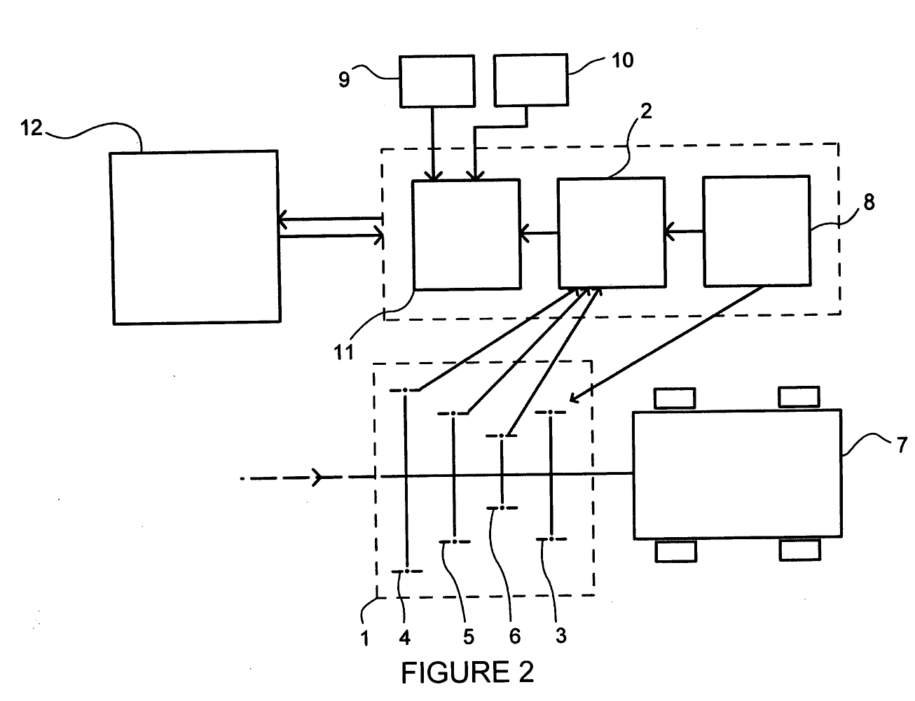

FIG. 2 represents schematically the measuring means, according to the invention;

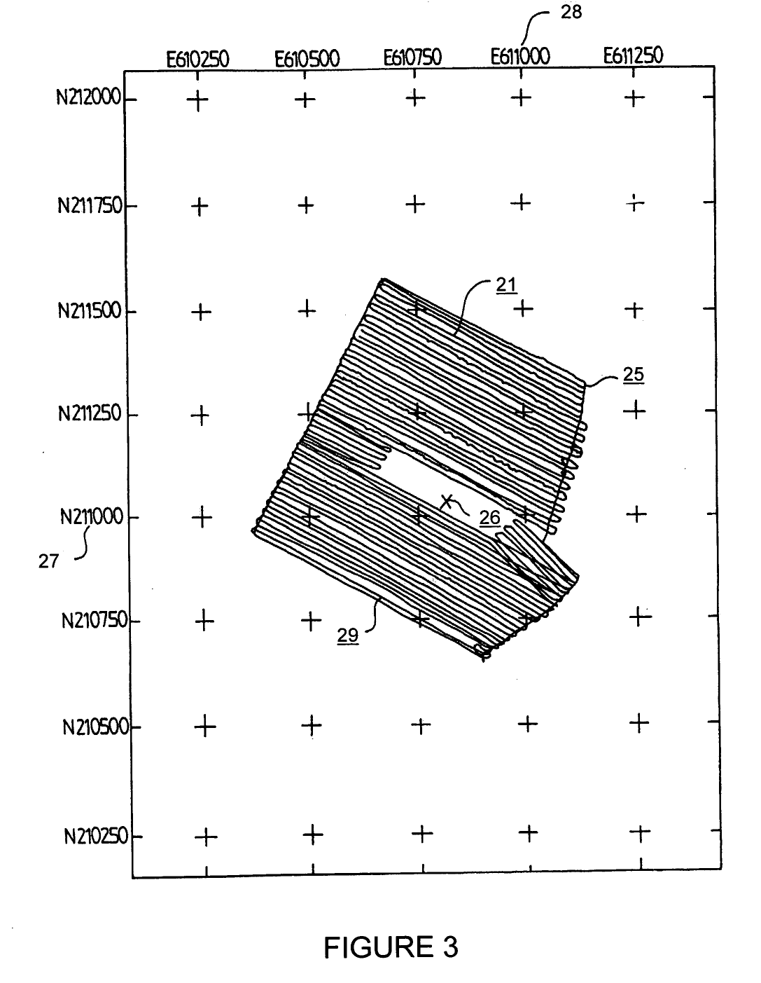

FIG. 3 is a map showing the path of the measuring means over a particular ground plot;

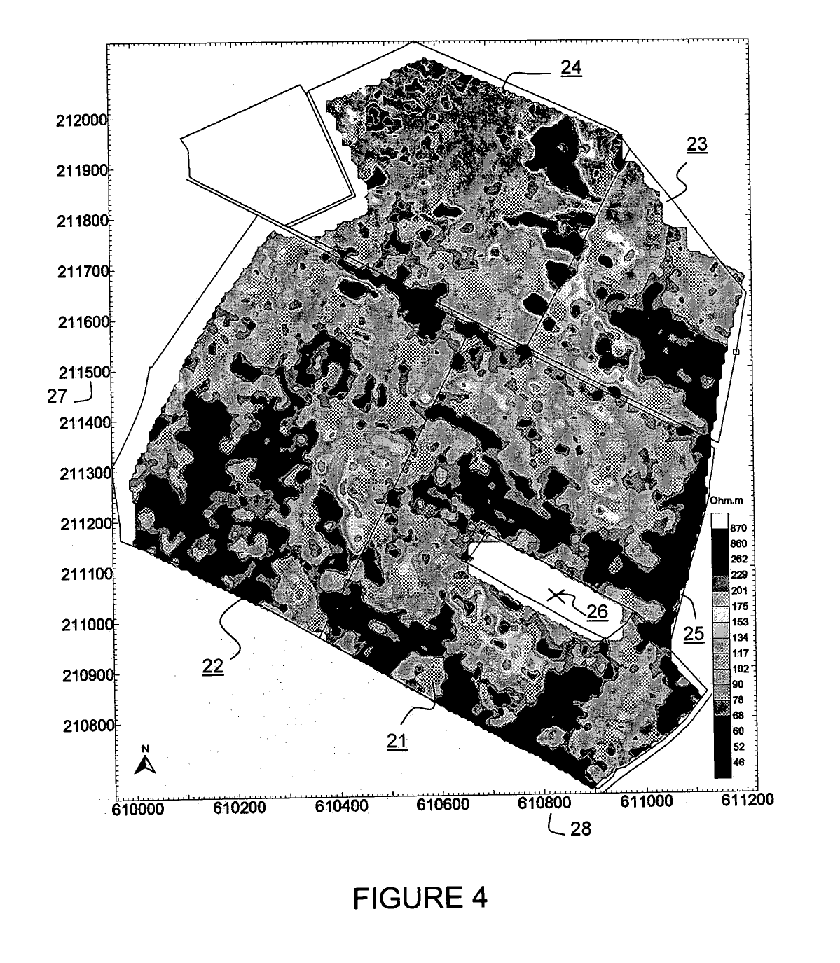

FIG. 4 is a set of maps of electrical resistivities obtained for a set of ground plots comprising the plot subject of FIG. 3;

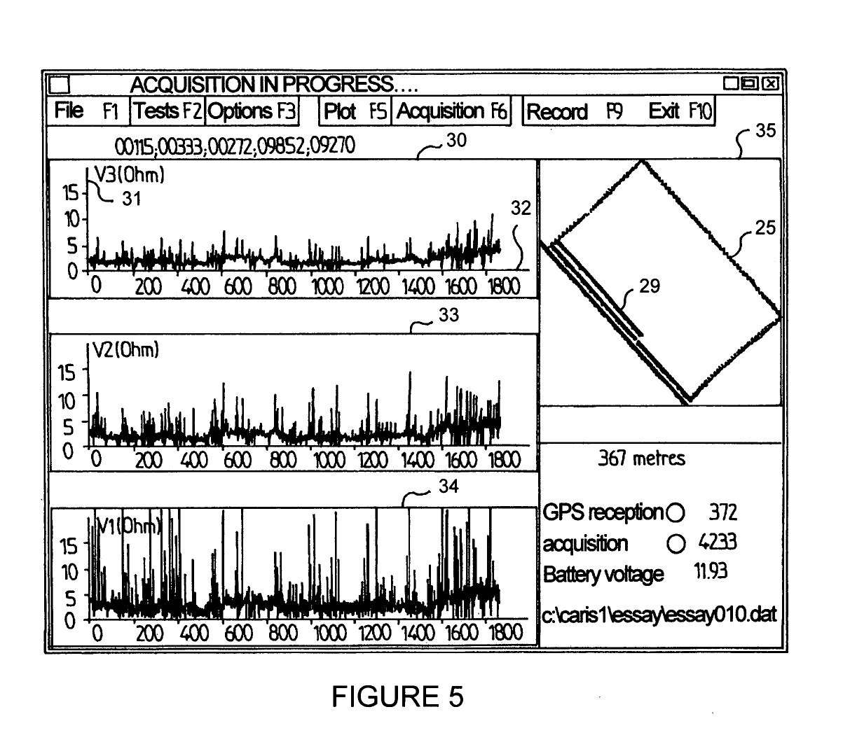

FIG. 5 shows an example type of real-time display windows: a profile showing the sequential variations for a given depth of the ground resistivity through the zone studied and a map showing the positioning of the measuring means.

The first step of the method represented on FIG. 1 consists of the acquisition of a set of measurements at given points of a ground plot to be mapped. These points are defined by the repetition of a same elementary mesh which cuts the zone of this plot into a grid of points. Said point grid is therefore defined as a regular arrangement of points on the plane of the surface of the ground plot. Each point is connected to another in a direction given by the length of the elementary mesh and in a direction perpendicular thereto, by the width of said elementary mesh. The dimensions of the elementary mesh on the plane of the surface are typically 0.1 m by 8 m. However, the length of this mesh, or sampling pitch, may be cut down to a few centimetres in the displacement direction of the measuring means.

The point grid being defined, measuring means 1 are moved around in the area to be mapped. n measurements of electrical resistivity 2 at each point are then made continuously during the displacement of the measuring means. By resistivity measurement 2 is meant either a galvanic resistivity measurement or an electrostatic resistivity measurement. The actual measuring means comprise an alternating current driven resistivity meter having k hinged axles 3-6. A quad 7 may, for instance, be implemented to drive the measuring means 1. By “quad” 7 is meant a four-wheel motorbike. One of the axles 3 enables injection of a preferably controlled current, i.e. with constant intensity, emitted by a source 8 in the ground whereas the n other axles 4-6 measure the resulting potentials thanks to electrode-wheels. The respective dimensions and location of said axles, and consequently, the whole structure of the measuring means enable to measure resistivity for a given point at n different depths. The value of n is greater than 3. The value of the current injected into the ground varies according to the nature of the grounds studied, but is situated between 0.1 and 20 mA.

The measurements of electrical resistivity 2 are georeferenced. To each resistivity measurement is therefore associated a couple of coordinates enabling to locate geographically said measurement on the plane of the surface of the ground plot to be mapped. These resistivity measurements are indeed triggered by measuring the position relative of the measuring means with respect to said point. This measurement of the relative position may be performed by a Doppler radar, an incremental encoder or any system 9 capable of delivering preferably TTL pulses, in relation of the displacement of the vehicle. The resistivity measurements triggered by a positioning measurement involve that resistivity measurements are performed according to the distance travelled and not based on a fixed time reference. There results that regardless of the displacement speed of the measuring means in the area to be mapped, the points measured are regularly spaced. The density of points measured is therefore homogenous.

The relative position measurement is moreover coupled to an absolute position measurement. The absolute system is a GPS 10, differential or not. The implementation of a differential absolute positioning system (dGPS) enables advantageously any displacement of the measuring means 1 in the ground area to be mapped. The prior art absolute positioning systems 10 enable acquisition of measurements approx. every second. According to the displacement speed of the measuring means 1, the relative positioning system 9 provides more measurements than the absolute positioning system 10. In an embodiment represented on FIG. 3, a number of ten relative measurements variable according to the speed generally ranging between 1 and 30 is obtained between the acquisition of two absolute measurements. The acquisition of electrical resistivity measurements 2 being triggered by a relative position measurement, the number of resistivity measurements is thus larger.

The three basic inputs of the system, obtained synchronously, correspond therefore to the voltage acquisitions on the n potential paths, the acquisitions of relative positioning measurements and finally, the acquisitions of absolute positioning measurements.

These inputs are processed by a microcontroller 11 (step 2, FIG. 1 b)) synchronously. In a particular embodiment, the microcontroller 11 receives at its input the electrical signal sent by the relative positioning system 9 and produces an output signal. This output signal is sent to the microcontroller 11. This signal triggers said measurements. The signals derived from the measurements are sent to the input of the microcontroller and are acquired synchronously. The microcontroller 11 then sends at its output, data which is representative of the signals received at its input. This data is finally sent in real time by the microcontroller 11 on a computer 12 (step 3, FIG. 1c)). This data is then processed digitally by a software. The various sets of measurements are thus processed statistically between two absolute coordinates. Oversampling of the resistivity and relative positioning measurements with respect to the absolute positioning measurements authorises such processing. Faulty resistivity values resulting, for instance, from the loss of contact of one of the electrodes with the ground are thereby eliminated The positioning measurements are also fine-tuned. In a preferred embodiment, the median algorithm is implemented for its fast execution and for fine control of the threshold beyond which the data is rejected.

The software enables to visualise (step 4, FIG. 1d)) simultaneously and in real time on two different display windows (FIG. 4), a first sequence showing the variations for a given depth of the ground resistivity along of the zone studied and a second window showing the positioning of the measurement points. Direct control of these measurements by visualisation enables to assess the validity of the measurements. A particular procedure has been programmed in order to determine the scale of the plot and therefore to be able to set the dimensions of the window representing visually the location of the measuring means (second window). This particular procedure calls for a preliminary survey before the acquisition of any measurement. This preliminary survey consists of a continuous displacement of the measuring means 1. The preliminary survey also gives the opportunity of assessing the variation domain of resistivity. In a preferred embodiment, the positioning window enables to visualise the positions in the French Lambert system after conversion of the absolute positioning measurements (satellite coordinates).

The first graphics enable direct visualisation of the resistivity measurements in relation to displacement since the calibration curves of the resistivity meter have been integrated to be able to let through potentials measured for a given controlled current to resistances and resistivities.

The sets of measurements and profiles can then be stored on the computer 12 (step 5, FIG. 1e)).

Continuous acquisition during displacement of the measuring means, of n measurements of electrical resistivity at each point of a ground plot calls for the implementation of measuring apparatus and of a measuring chain whereof the response time is compatible with the displacement speed of said measuring means. The same speed is limited by the nature of the terrain, the distance to be travelled between two measurements (the length of the elementary mesh), and by the response time of the external apparatus, for example, of the spreading means, which might be coupled to said measuring means. Real-time processing of the data collected, required by such external apparatus is quick enough so as not to limit the speed of the whole device. The computer 12 controls directly such external apparatus (step 5, FIG. 1e)). In an embodiment, spreading means are coupled to the georeferenced measuring means. The information on the nature of the ground processed by the computer 12 enables to adapt, in real time, the intrant dose necessary to a specific area to be treated.

The parallelism of the measurements during continuous displacement is provided by orientation means, for instance, a guiding system. This guiding system linked with the differential absolute positioning measurements (dGPS) enables the acquisition of a homogeneous density of measurements over the whole ground plot to be mapped.

FIGS. 3 and 4 show an example of maps obtained during the survey of a farm in the French region of Champagne Berrichonne, in the Cher department, in the South of Bourges. Four plots were studied 21, 22, 23, 24 with a total surface area of 120 hectares. The dimensions of the elementary mesh on the plane of the surface area to be studied are 1 m by 12 m. New interpolation for a 6 m by 6 m mesh has been performed during digital data processing. The controlled current used was 20 mA by reason of the conducting nature of the terrain. The average data acquisition speed was of the order of 1.2-1.5 m/s. FIG. 3 represents the displacement of the measuring means over one of the plots 21 called “Les Bois Forts”. The periphery 25 of the plot delineates the external borders of the zone to be mapped. The starting point 26 of the measuring means is marked by its coordinates in the Lambert system 27 and 28. The dashes 29 represent either out or return displacement of the measuring means over the plot. FIG. 4 represents the resistivity signal measured in relation to the displacement for a 0.5 m integrated depth. The results obtained for the four plots 21, 22, 23, 24 have been gathered. The acquisition time cumulated to produce FIG. 3 is 17 hours. This map corresponds to 305 000 measurements.

FIG. 5 shows a typical example of display windows as they may appear in real time to the user during the acquisition of measurements. The graph 30 shows the variations of the ground electrical resistivity 31, for a given depth according to relative displacement of the measuring means 32. The graph 30, 33 and 34 correspond to resistivity measurements at different ground depths, which measurements range generally between 0 and 2 m. The graph 35 shows real time absolute positioning of the measuring means as described on FIG. 3.

This method may be used advantageously in Precision Agriculture (P. A.). Indeed, associated with seed spreading means, such method should enable real time adaptation of the intrant dose necessary to a specific zone to be treated. There results significant time-saving and cost reduction. It should also provide more environment-friendly guarantee. This method may also be used advantageously within the framework of the prospection of archaeological sites.

1. A method for processing georeferenced electrical resistivity measurements for electrical ground mapping wherein:
the area of a ground to be mapped is cut into a grid of points defined by the repetition of the same elementary mesh,
measuring means are moved in the area to be mapped,
as measuring means are moved, at least one measurement of the electrical resistivity is made continuously at each point,
positioning means are used for geographical and absolute referencing of the measurement associated with each point,
the data recorded is processed digitally,
a map showing the variations for a given depth of the electrical resistivity of the ground is visualised, characterised in that:
the electrical resistivity is recorded for each point at n different depths, n being at least equal to 3,
said positioning means enable to obtain, for each point measured, a relative displacement measurement with respect to the previous point,
the three sets of measurements obtained are sent to a microcontroller which synchronises the acquisitions.

2. A method for processing electrical resistivity measurements according to claim 1, characterised in that the data sent by the microcontroller to a computer is processed digitally and in real time.

3. A method for processing electrical resistivity measurements according to one of claims 1 and 2, characterised in that a profile showing the sequential variations for a given depth of the ground resistivity through the area studied and a map showing the position of the measuring means are visualised simultaneously and in real time on two different display windows.

4. A method for processing electrical resistivity measurements according to any one of claims 1 to 3, characterised in that before collecting said measurements, the scale of the map of the second display window is defined, during the preliminary survey of the area to be mapped, whereas said survey is recorded on the computer by a particular programmed procedure.

5. A method for processing electrical resistivity measurements according to any one of claims 1 to 4, characterised in that a guiding system is used to control the displacement of the means for measuring the relative displacements, the electrical resistivity and the absolute positioning between the points.

6. A method for processing electrical resistivity measurements according to any one of claims 1 to 5, characterised in that the measurement of the relative displacements is obtained by a Doppler radar.

7. A method for processing electrical resistivity measurements according to any one of claims 1 to 5, characterised in that the measurement of the relative displacements is obtained by an incremental encoder.

8. A method for processing electrical resistivity measurements according to any one of claims 1 to 5, characterised in that the measurement of the relative displacements is obtained by a system capable of delivering TTL pulses according to the displacement of the measuring means.

9. A method for processing electrical resistivity measurements according to any one of claims 1 to 8, characterised in that the sets of resistivity measurements and of relative positioning measurements between two absolute coordinates are processed statistically at the computer in order to eliminate faulty resistivity values and to fine-tune the positioning measurements.

10. A method for processing electrical resistivity measurements according to any one of claims 1 to 9, characterised in that the resistivity is measured at constant current.
